(19) United States
(12) Patent Application Publication
(10) Pub. No.: US 2017/0348578 A1
(43) Pub. Date: Dec. 7, 2017

(54) PORTABLE COCKING PRACTICE DEVICE

(71) Applicant: Jai Choon SIN, Seoul (KR)

(72) Inventor: Jai Choon SIN, Seoul (KR)

(21) Appl. No.: 15/541,353

(22) PCT Filed: Dec. 22, 2015
(86) PCT No.: PCT/KR2015/014091

§ 371 Date: Jun. 30, 2017

(30) Foreign Application Priority Data
Dec. 30, 2014 (KR) 10-2014-0193276

(51) Int. Cl. A63B 69/36; G09B 19/00

(52) U.S. Cl. CPC A63B 69/36; G09B 19/0038; A63B 2225/09

(57) ABSTRACT

A portable cocking practice device according to an embodiment of the present invention comprises: a first shaft part having a hollow therein and having an opening at one end thereof, which is connected to the hollow; a second shaft part inserted and fixed into the hollow of the first shaft part through the opening of the first shaft part over the entire length or a part of the length thereof; and an rod withdrawing part received inside the second shaft part so as to withdraw a given rod out of the second shaft part by an uncocking operation of a golf swing, thereby improving a user's convenience and portability while increasing similarity to the actual golf swing and enabling a cocking practice according to each golf club.

### TECHNICAL FIELD

The present application claims priority to Korean Patent Application No. 10-2014-0193276 filed in the Korean Intellectual Property Office on Dec. 30, 2014, the entire contents disclosed in the description and drawings of which are incorporated herein by reference.

The present invention relates to a portable cocking practice device and, more particularly, to a portable cocking practice device while increasing similarity to the actual golf swing and enabling a cocking practice according to each golf club and also improving a user's convenience and portability.

### BACKGROUND ART

Recently, with an increase of the publicity of golf sports and the spread of a so-called indoor golf simulator corresponding to a golf simulation system, people who try to enjoy golf as leisure sports are suddenly increasing. In line with such a trend, the general public interest in a systematic and efficient golf swing posture is increasing daily and the demand for golf swing practice devices is also suddenly increasing.

In general, a golf swing is a motion mechanism, including a take back in which a club is taken back in a direction opposite a target, a back swing in which cocking for breaking the wrist is performed, a down swing in which uncocking for releasing the cocked wrist while the club is swung toward the target through transition at the top position of the back swing is performed, an impact in which a ball is hit by the head of the club, a follow through in which the club continues to proceed along the swing path after the impact, and a finish motion in which the swing is finished.

The cocking and uncocking operations of the operation of the golf swing are core operation for increasing the driving distance of a ball by maximizing the head speed of a club during the swing. In order for the cocking and uncocking operations to be efficiently performed, so-called delay hitting in which the ball is hit while hands that hold grips are ahead of the head of the club on a swing plane must be performed. That is, lagging in which the cocking state is maintained right before the impact as much as possible is required. Common amateur players require accurate understanding of the corresponding mechanism and a great amount of practice in order to correctly performing such cocking and uncocking operations.

Meanwhile, in the golf sports, 14 clubs having various lengths and weights from a driver to a sand wedge are used in average. The position of a ball where each club is located ahead of a golfer upon addressing is different. As a result, an impact point of time at which a corresponding head comes into contact with a ball is different for each club. Accordingly, a golfer who tries to improve his or her golf skill must be accustomed to a swing by performing a separate cocking practice for each club having a different length, weight and impact point of time.

As disclosed in Korean Patent Application Publication No. 1020070031370, etc., however, the existing golf swing practice devices are problematic in that they do not separately take into consideration cocking and uncocking operation practices, that is, the core operation of an efficient golf swing, and do not propose a technology capable of improving a similarity with an actual golf swing.

More specifically, as disclosed in Korean Patent Application Publication No. 1020100129362, etc., the existing golf swing practice devices has a problem in that they do not propose a technology which enables cocking practices to be performed using a single practice device with respect to each of golf clubs which have different lengths, weights and impact points of time and range from the driver to the sand wedge. Furthermore, they do not propose a technology which provides a feeling similar to an actual golf club upon practicing a swing and also improves portability while moving.

### SUMMARY OF THE INVENTION

The present disclosure provides a portable cocking practice device in which enables a user's to have a feeling of an impact like an actual golf swing and also to check whether correct cocking and uncocking operations are performed in person.

Furthermore, the present disclosure provides a portable cocking practice device in which enables cocking practices for each golf club in accordance with golf clubs having various lengths from a driver to a sand wedge and also improves user convenience and portability.

Furthermore, the present disclosure provides a portable cocking practice device in which increases a similarity with an actual golf swing in which an impact point of time is different for each golf club and improves a cocking practice effect.

According to an exemplary embodiment of the present disclosure provides a portable cocking practice device may include a first shaft part having a hollow therein and an having opening at one end thereof, which is connected to the hollow; a second shaft part inserted and fixed into the hollow of the first shaft part through the opening part of the first shaft part over the entire length or a part of length thereof; and an rod withdrawing part received inside the second shaft part so as to withdraw a given rod out of the second shaft part by an uncocking operation of a golf swing, wherein the second shaft part may include a second shaft body which has an insertion length indication part having the insertion length of each golf club that is a subject of a cocking practice indicated in an outer face and accommodates an rod withdrawing part therein so that a rod of the rod withdrawing part is given rod out of through an opening part at one end; and insertion position adjustment means for fixing the second shaft body inserted into the first shaft part to the first shaft part at a corresponding insertion position in response to the insertion length of each golf club indicated in the insertion length indication part.

In an embodiment, the first shaft part may include a first shaft body of a hollow pipe form into which the second shaft part is inserted through an opening part at one end and a grip part which is coupled to the other end of the first shaft body and has protrusions for a grip which guide a grip in position on an outer face.

In an embodiment, the insertion position adjustment means may include a bolt part for adjusting an insertion position which is coupled and fixed to the second shaft body and a nut part for adjusting an insertion position which is screwed onto the bolt part for adjusting an insertion position and fixed to the inner circumference surface of the first shaft part.

In an embodiment, the nut part for adjusting an insertion position may have guide protrusions which guide a movement in the insertion direction of the second shaft part within the first shaft part in an outer circumference surface.

In an embodiment, the first shaft part may have guide grooves corresponding to the guide protrusions in an inner circumference surface.

In an embodiment, the rod withdrawing part may include an withdrawing rod which has one end accommodated in the second shaft body and the other end located outside the second shaft body; a head part which has a diameter greater than the internal diameter of the second shaft body and is coupled to the other end of the withdrawing rod outside the second shaft body; and an elastic member which is disposed within the second shaft body to restrict the one end of the withdrawing rod by an elastic force and withdraw a given rod out of the second shaft body in a specific length by an uncocking operation of a golf swing.

In an embodiment, the head part may have a plurality of air resistance faces which increases air resistance upon playing a golf swing.

In an embodiment, the elastic member may be a coil type spring member having one end clamped to the one end of the withdrawing rod by a specific coupling member and the other end fixed within the second shaft body by a specific fixing member.

In an embodiment, the withdrawing rod may have screw threads in at least part of an outer circumference surface. The head part may have a through hole screwed onto the screw threads of the withdrawing rod and may be screwed onto the withdrawing rod through the through hole to withdraw a given rod out of the second shaft body in a specific length along a screw coupling degree.

In an embodiment, the portable cocking practice device may further include a member for adjusting an impact point of time which is disposed in the withdrawing rod portion between the head part coupled to the other end of the withdrawing rod and the second shaft body and withdraw a given rod out of the second shaft body in a specific length by separating the head part and the second shaft body.

### Advantageous Effects

In accordance with the present invention, a user's can have a feeling of an impact like an actual golf swing and also check whether the user takes a correct cocking and uncocking operation in person because the rod within the shaft coupled to a head is withdrawn when the user takes the uncocking operation of a normal golf swing.

In particular, cocking practices for each golf club are made possible and a user's convenience and portability can also be improved because the length and weight of the shaft can be adjusted in response to golf clubs having various lengths and weights from a driver to a sand wedge.

Furthermore, a similarity with an actual golf swing in which an impact point of time is different for each golf club can be increased and a cocking practice effect can be improved because an impact point of time at which the rod within the shaft is withdrawn as much as possible can be adjusted.

Furthermore, a person having ordinary skill in the art to which the present invention pertains will obviously understand that various embodiments according to the present invention can solve several objects not described above from the following description.

### BRIEF DESCRIPTION OF THE DRAWINGS

FIG. 1 is a perspective view a portable cocking practice device according to an exemplary embodiment of the present invention.

FIG. 2 is an exploded perspective view a portable cocking practice device according to an exemplary embodiment of the present invention.

FIG. 3 is a perspective view an example of a second shaft part.

FIG. 4A is a cross-sectional view an example of a first shaft part into which a nut part for adjusting an insertion position has been inserted.

FIG. 4B is a cross-sectional view showing another example of the first shaft part into which the nut part for adjusting an insertion position has been inserted.

FIG. 5 is a perspective view a mode for a driver practice in the portable cocking practice device according to an exemplary embodiment of the present invention.

FIG. 6 is a perspective view a portable mode in the portable cocking practice device according to an exemplary embodiment of the present invention.

FIG. 7A is a cross-sectional view an example of a rod withdrawing part.

FIG. 7B is a cross-sectional view the maximum withdraw state of the rod withdrawing part.

FIG. 8 is a perspective view the state upon uncocking of the portable cocking practice device according to an exemplary embodiment of the present invention.

FIG. 9A is a perspective view an example of a member for adjusting an impact point of time.

FIG. 9B is a plan view the member for adjusting an impact point of time in FIG. 9A.

FIG. 10 is a diagram a method for adjusting an impact point of time of the portable cocking practice device according to an exemplary embodiment of the present invention.

FIG. 11 is a diagram a method for adjusting an impact point of time of the portable cocking practice device according to another exemplary embodiment of the present invention.

### DETAILED DESCRIPTION OF THE EMBODIMENTS

Hereinafter, preferred embodiments of the present invention are described in detail with reference to the accompanying drawings in order to clarify means for solving the technical objects of the present invention. In the accompanying drawings, the same reference numerals denotes the same member. In describing the present invention, a detailed description of a related known technology will be omitted if it is deemed to make the gist of the present invention unnecessarily vague. Furthermore, the following terms are terms defined by taking into consideration functions in the present invention and may be changed depending on an intention or practice of a designer, a manufacturer, etc. Accordingly, the definition of the terms should be made based on contents over the entire description.

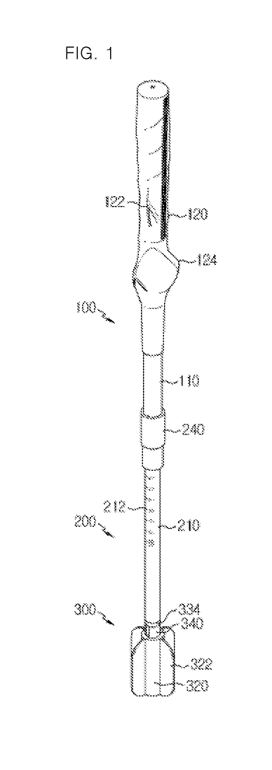

FIG. 1 shows a portable cocking practice device according to an exemplary embodiment of the present invention in a perspective view form.

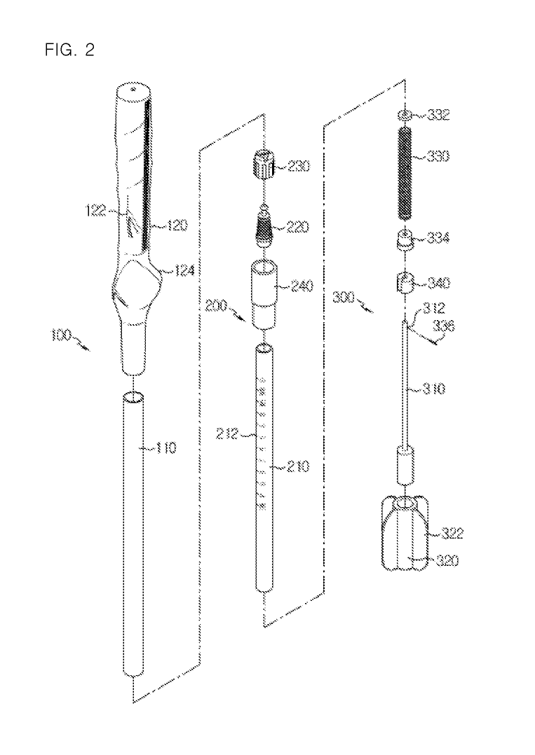

FIG. 2 shows the portable cocking practice device according to an exemplary embodiment of the present invention in an exploded perspective view form.

As shown in FIGS. 1 and 2, the portable cocking practice device according to the present invention may includes a first shaft part 100, a second shaft part 200 and a rod withdrawing part 300.

The first shaft part 100 having a hollow therein and having an opening part connected to the hollow at one end. The first shaft part 100 may include a first shaft body 110 and a grip part 120. In this case, the first shaft body 110 may be configured in the form of a hollow pipe into which the second shaft part 200 is inserted through the opening part at one end. Furthermore, the grip part 120 is coupled to the other end of the first shaft body 110 and may include protrusions 122 and 124 for a grip which guide a user's grip in position on the outer face of the grip part. The protrusions for a grip allow a user's to take a correct grip posture, thus being capable of improving a golf swing exercise effect.

Some or the entire length of the second shaft part 200 is inserted into the hollow of the first shaft part 100 through the opening part of the first shaft part 100. The second shaft part 200 may include a second shaft body 210 and insertion position adjustment means. In this case, the second shaft body 210 has an insertion length indication part 212 in which the insertion length of each golf club, that is, a target of cocking practices, is indicated in the outer face of the second shaft body. The second shaft body 210 accommodates the rod withdrawing part 300 therein so that a specific rod of the rod withdrawing part 300 is drawn out through the opening part at one end. To this end, the second shaft body 210 may be configured in the form of a hollow pipe. Furthermore, the insertion position adjustment means fixes the second shaft body 210, inserted into the first shaft part 100 depending of the insertion length of each golf club indicated in the insertion length indication part 212, to the first shaft part 100 at a corresponding insertion position. In an embodiment, the insertion position adjustment means may include a bolt part 220 for adjusting an insertion position and a nut part 230 for adjusting an insertion position. In this case, the bolt part 220 for adjusting an insertion position is coupled to the other end of the second shaft body 210 and fixed thereto. Furthermore, the nut part 230 for adjusting an insertion position is screwed onto the bolt part 220 for adjusting an insertion position and fixed to the inner circumference surface of the first shaft part 100. To this end, the diameter of a portion that belongs to the bolt part 220 for adjusting an insertion position and that is inserted into the nut part 230 for adjusting an insertion position may be configured to increase as screw coupling with the nut part 230 for adjusting an insertion position proceeds. The nut part 230 for adjusting an insertion position may be made of a specific elastic material.

In another embodiment, the insertion position adjustment means may include a specific trapping groove (not shown) or a trapping protrusion (not shown). When the second shaft body 210 is inserted into the first shaft part 100, the trapping groove or the trapping protrusion may be configured to be coupled to a specific trapping protrusion or trapping groove provided in the inner circumference surface of the first shaft part 100 and to fix the second shaft body 210 to the first shaft part 100.

As will be described hereinafter, a user's may set a mode for a golf club on which cocking practices are to be performed by properly inserting the second shaft part 200 into the first shaft part 100 with reference to the insertion length indication part 212 of the second shaft part 200 and fixing the second shaft part 200 to the first shaft part 100 using the insertion position adjustment means.

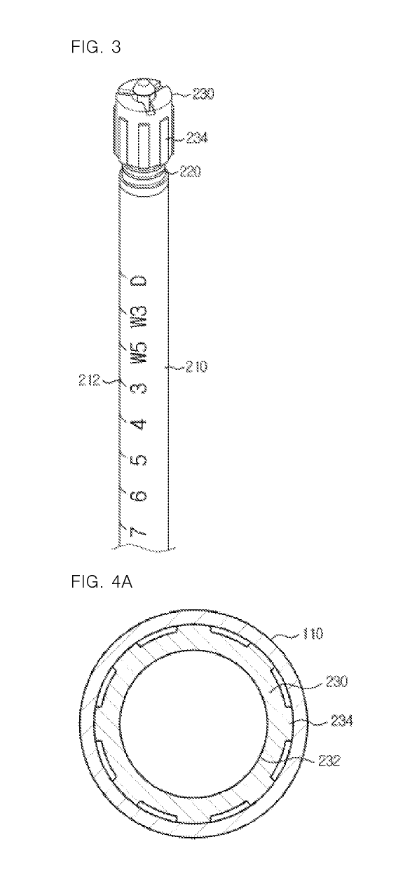

FIG. 3 shows an example of the second shaft part in a perspective view form. As shown in FIG. 3, when a user's attempts a cocking practice for a specific club, the user inserts the second shaft part 200 into the first shaft part 100 up to an indication corresponding to the corresponding club with reference to the insertion length indication part 212 provided in the second shaft body 210. Next, a user's turns the second shaft part 200 to screw the bolt part 220 for adjusting an insertion position and the nut part 230 for adjusting an insertion position so that the outer circumference surface of the nut part 230 for adjusting an insertion position is closely fixed to the inner circumference surface of the first shaft part 100. To this end, the outer circumference surface of the nut part 230 for adjusting an insertion position may have guide protrusions 234 for guiding a movement in the insertion or withdrawing direction of the second shaft part 200 within the first shaft part 100.

FIG. 4A shows an example of the first shaft part into which the nut part for adjusting an insertion position has been inserted in a cross-sectional view form.

As shown in FIG. 4A, screw threads for screwing with the bolt part 220 for adjusting an insertion position have been formed in the inner circumference surface 232 of the nut part 230 for adjusting an insertion position. The guide protrusions 234 may be formed in the outer circumference surface of the nut part 230. The guide protrusions 234 are formed to guide a movement in the insertion or withdraw direction of the second shaft part 200 by an external force through contact with the inner circumference surface of the first shaft part 100, that is, the inner circumference surface of the first shaft body 110, and to have friction enough for screwing if the bolt part 220 for adjusting an insertion position has been released. In contrast, the diameter of the nut part 230 for adjusting an insertion position as the screwing between the bolt part 220 for adjusting an insertion position and the nut part 230 for adjusting an insertion position proceeds, and thus the guide protrusions 234 is closely fixed to the inner circumference surface of the first shaft body 110.

FIG. 4b shows another example of the first shaft part into which the nut part for adjusting an insertion position has been inserted in a cross-sectional view form.

As shown in FIG. 4b, the first shaft body 110 of the first shaft part 100 may have guide grooves 112 corresponding to the guide protrusions 234 in the inner circumference surface thereof. The guide grooves 112 can prevent the idling of the nut part 230 for adjusting an insertion position attributable to the abrasion of the guide protrusions 234 upon screwing between the nut part 230 for adjusting an insertion position and the bolt part 220 for adjusting an insertion position.

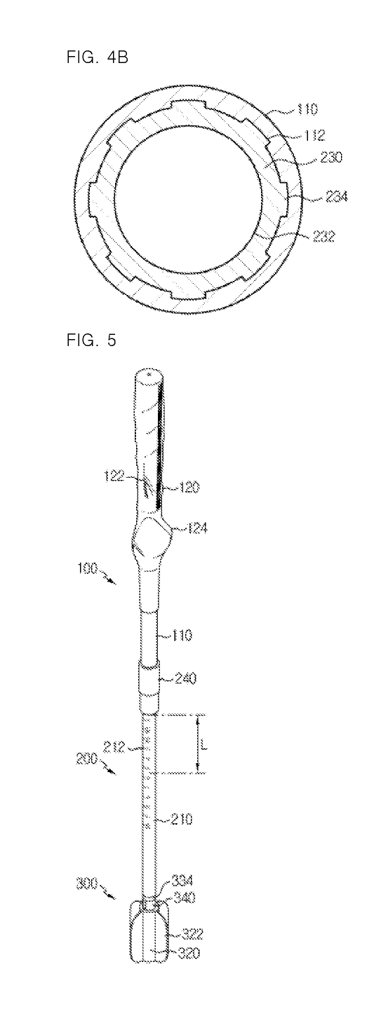

FIG. 5 shows a mode for a driver practice in the portable cocking practice device according to an embodiment of the present invention in a perspective view form.

As shown in FIG. 5, when a user attempts cocking and uncocking practices upon swinging a driver, the user may set the portable cocking practice device in the mode for a driver practice by inserting the second shaft part 200 into the first shaft part 100 up to D, that is, a corresponding indication point of the insertion length indication part 212, or withdrawing the second shaft part 200 from the first shaft part 100. Furthermore, when the user attempts a change from the mode for a driver practice to a mode for an iron No. 6 practice, the user may set the portable cocking practice device in the mode for an iron No. 6 practice by further inserting the second shaft part 200 into the first shaft part 100 up to 6, that is, a corresponding indication point of the insertion length indication part 212, in a specific length L.

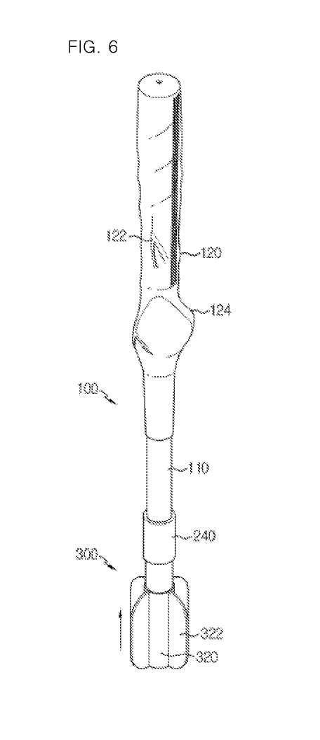

FIG. 6 shows a portable mode in the portable cocking practice device according to an embodiment of the present invention in a perspective view form.

As shown in FIG. 6, the portable cocking practice device may be changed to the portable mode by fully inserting the second shaft part 200 into the first shaft part 100.

As described above, the present invention enables a cocking practice for each golf club and also can improve user convenience and portability by allowing a user's to adjust a shaft length in accordance with golf clubs having various lengths from a driver to a sand wedge.

In an embodiment, the second shaft part 200 may further include a finishing member 240 which protects a user against a cutting plane formed on the opening part side of the first shaft part 100. The finishing member 240 may be configured in the form of a hollow pipe having one end into which the first shaft part 100 is inserted and fixed and the other end through which the second shaft part 200 is moved and inserted into the first shaft part 100. Furthermore, the other end of the finishing member 240 may be configured to indicate the insertion degree of the second shaft part 200 on the insertion length indication part 212 of the second shaft part 200.

Next, the rod withdrawing part 300 is accommodated in the second shaft part 200, so a specific rod is withdraw a given rod out of the second shaft part 200 by an uncocking operation of a golf swing.

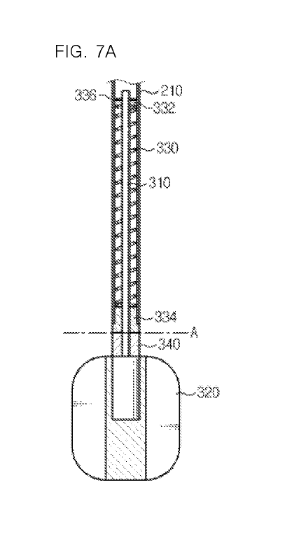

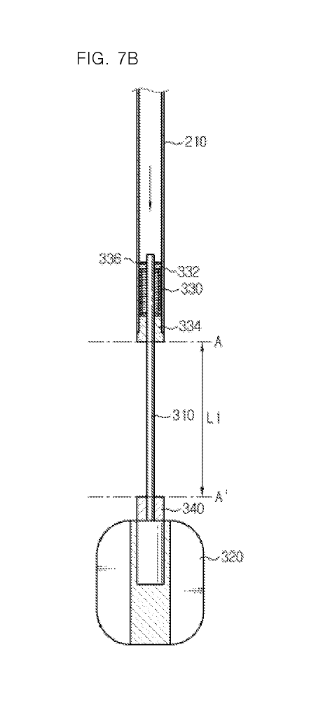

FIG. 7A shows an example of the rod withdrawing part in a cross-sectional view form.

FIG. 7B shows the maximum withdraw state of the rod withdrawing part in a cross-sectional view form.

As shown in FIGS. 7A and 7B, the rod withdrawing part 300 may include a withdrawing rod 310, a head part 320 and an elastic member 330.

The withdrawing rod 310 has one end accommodated in the second shaft part 200, that is, the hollow within the second shaft body 210, and the other end located outside the second shaft part 200. In some embodiments, the other end of the withdrawing rod 210 may be configured to have a diameter greater than the internal diameter of the second shaft body 210.

The head part 320 has a diameter greater than the internal diameter of the second shaft body 210 and is coupled to the other end of the withdrawing rod 310 outside the second shaft part 200. In an embodiment, the head part 320 may be configured to have a plurality of air resistance faces 322. The air resistance faces 322 can increase a golf swing exercise effect by increasing air resistance upon playing a golf swing.

The elastic member 330 is disposed in the hollow within the second shaft body 210, and it restricts the one end of the withdrawing rod 310 by an elastic force and withdraws the withdrawing rod 310 to the outside of the second shaft part 200 by a length L1 from A to A′ by an uncocking operation of a golf swing. In an embodiment, the elastic member 330 may be a coil type spring member 330 having one end clamped to the one end of the withdrawing rod 310 by specific clamping members 332 and 336 and the other end fixed to the inside of the second shaft body 210 by a specific fixing member 334. For example, the rod withdrawing part 300 may be configured so that the one end of the withdrawing rod 310 is inserted into the center hole of the spring member 330, a ring type member 332 for compressing the spring member 330 upon drawing the withdrawing rod 310 and a ferrule 334 for fixing the spring member 330 so that it does not deviate from the inside of the second shaft body 210 are inserted into the withdrawing rod 310 at the top and bottom of the spring member 330, respectively, and a support pin 336 for supporting the ring type member 332 upon drawing the withdrawing rod 310 is inserted into the through hole 312 formed in the diameter direction at the one end of the withdrawing rod 310.

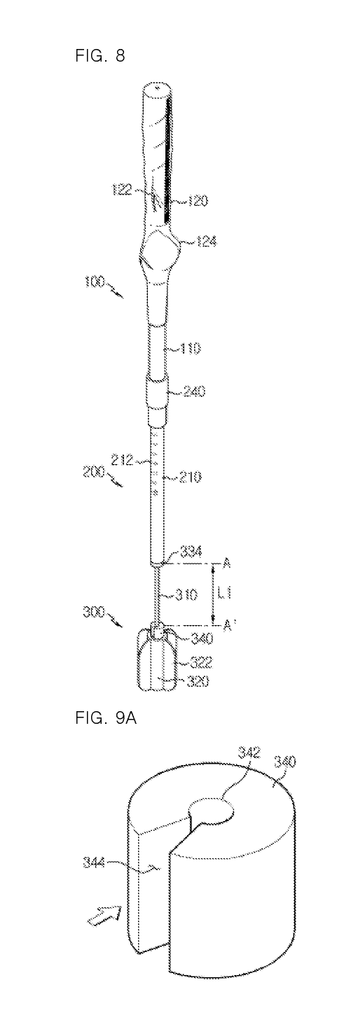

FIG. 8 shows the state upon uncocking of the portable cocking practice device according to an exemplary embodiment of the present invention in a perspective view form.

As shown in FIG. 8, the portable cocking practice device according to the present invention withdraws the withdrawing rod 310 to which the head part 320 has been coupled when a user's performs an uncocking operation of a golf swing. Furthermore, when an accurate cocking and uncocking operation is performed, the spring member 330 is compressed to a maximum extent, so a maximum withdrawn state in which the withdrawing rod 310 is drawn to the maximum length L1 is generated. When the maximum withdraw state is generated, the user's have a feeling of a specific impact and can check whether he or she has performed a correct cocking and uncocking operation oneself through such a feeling of an impact.

Meanwhile, as described above, in round of golf, 14 clubs having various lengths and weights from a driver to a sand wedge are used in average. The position of a ball placed ahead of a golfer upon addressing is different for each club. As a result, an impact point of time at which the head of each club comes into contact with a ball is different. Accordingly, the portable cocking practice device according to an exemplary embodiment of the present invention may further include a member 340 for adjusting an impact point of time. The member 340 for adjusting an impact point of time is disposed at the portion of the withdrawing rod 310 between the head part 320 coupled to the other end of the withdrawing rod 310 and the second shaft body 210, and separate the head part 320 and the second shaft body 210 so that the withdrawing rod 310 coupled to the head part 320 is previously withdraw a given rod out of the second shaft body 210 in a specific length. As described above, when the initial withdraw length of the withdrawing rod 310 is changed by the member 340 for adjusting an impact point of time, the initial elastic force of the elastic member 330 that restricts the withdrawing rod 310 prior to a golf swing is changed. Accordingly, a point of time at which the withdrawing rod 310 reaches the maximum withdraw state during an uncocking operation, that is, an impact point of time at which, is also changed.

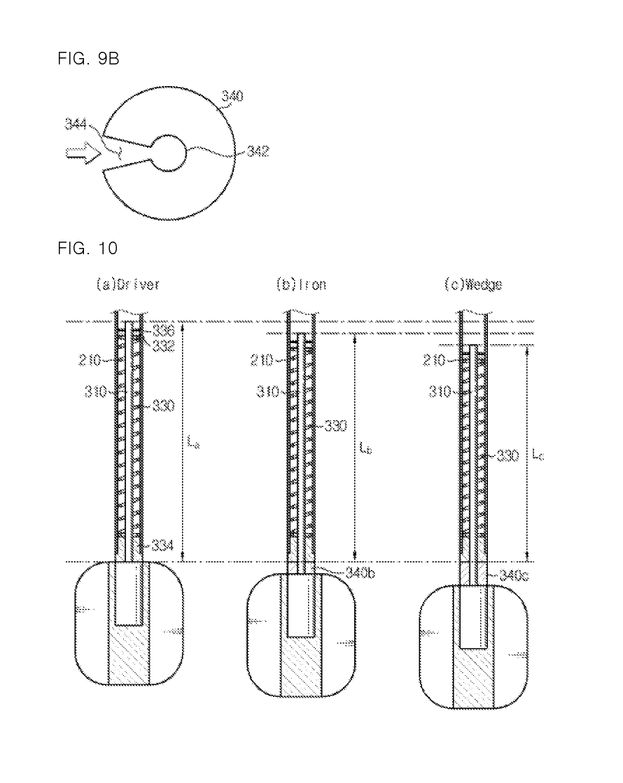

FIG. 9A shows an example of the member for adjusting an impact point of time in a perspective view form.

FIG. 9B shows the member for adjusting an impact point of time in FIG. 9A in a plan view form.

As shown in FIGS. 9A and 9B, the member 340 for adjusting an impact point of time may include a through hole 342 and an insertion slot 344. The member 340 for adjusting an impact point of time has a length corresponding to the initial withdraw length of the withdrawing rod 310 or the initial length of the spring member 330, and may have a diameter supported by the second shaft body 210 and the head part 320. That is, the external diameter of the member 340 may be configured to be greater than the internal diameter of the second shaft body 210, and the internal diameter of the member 340 may be configured to be smaller than the external diameter of the second shaft body 210 and the external diameter of the head part 320. In this case, the through hole 342 penetrates the member 340 in the length direction. Furthermore, the insertion slot 344 is formed in the diameter direction of the member 340 so that the withdrawing rod 310 is tightly fit into the insertion slot 344 and inserted into the through hole 342. As described above, a user's can adjust an impact point of time upon playing a golf swing by adjusting the initial withdraw length of the withdrawing rod 310 prior to the golf swing using the members for adjusting an impact point of time which have various lengths.

FIG. 10 shows a method for adjusting an impact point of time in the portable cocking practice device according to an exemplary embodiment of the present invention.

As shown in FIG. 10, the portable cocking practice device according to an exemplary embodiment of the present invention may be configured so that the member for adjusting an impact point of time is not mounted on the withdrawing rod 310 in the mode a for a driver practice. In this case, the initial length Lₐ of the spring member 330 accommodated in the second shaft body 210 becomes a maximum, and the longest time is taken for the withdrawing rod 310 to reach the maximum withdraw state upon uncocking operation. That is, an impact point of time is the slowest like an actual driver swing. For example, if a user's is a right-handed golfer, an impact in the mode for a driver practice is generated more on the left side than other modes. Meanwhile, in a mode b for an iron practice, a member 340b for adjusting an impact point of time which has a length for an iron practice may be mounted on the withdrawing rod 310. In this case, the initial length L_{b} of the spring member 330 is reduced as short as the length of the member 340b for adjusting an impact point of time, and a point of time at which the maximum withdraw state of the withdrawing rod 310 is reached upon uncocking operation becomes faster than that in the mode for a driver practice. That is, an impact point of time becomes faster than that in the driver swing like an actual iron swing. Furthermore, in a mode c for a wedge practice, a member 340c for adjusting an impact point of time which has a length for a wedge practice may be mounted on the draw-out rod 310. In this case, the initial length L_{c}, of the spring member 330 is further reduced as short as the length of the member 340c for adjusting an impact point of time, and a point of time at which the withdrawing rod 310 reaches the maximum draw-out state upon uncocking operation becomes faster than that in the mode for an iron practice. That is, an impact point of time is the fastest like an actual wedge swing. For example, if a user is a right-handed golfer, an impact in the mode for a wedge practice is generated more on the right side than other modes.

In another exemplary embodiment, the member 340 for adjusting an impact point of time may include a plurality of members depending on a mode of the portable cocking practice device. Furthermore, the member 340 for adjusting an impact point of time may be configured to adjust the total weight of the portable cocking practice device by making different the weight of the member 340 for adjusting an impact point of time which is mounted in each mode as if each golf club actually has a different weight.

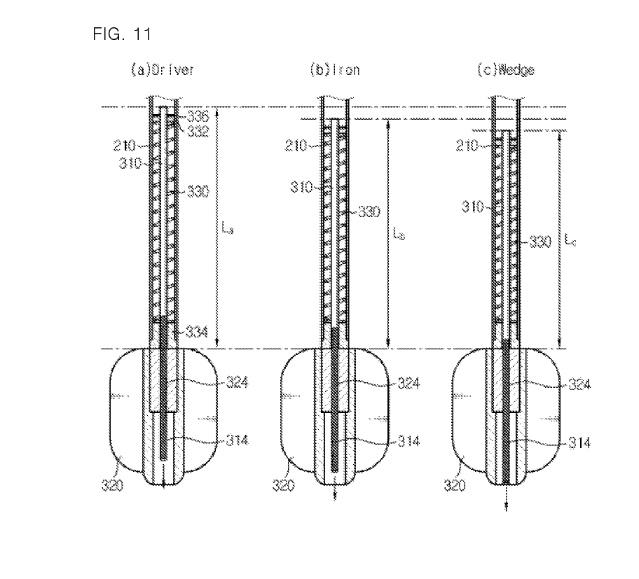

FIG. 11 is a diagram shows a method for adjusting an impact point of time of the portable cocking practice device according to another exemplary embodiment of the present invention.

As shown in FIG. 11, the portable cocking practice device according to another exemplary embodiment of the present invention may adjust the initial draw-out length of the withdrawing rod 310 or the initial length of the spring member 330 using the head part 320. In this case, the withdrawing rod 310 may have screw threads 314 in at least part of the outer circumference surface thereof Furthermore, the head part 320 may have a through hole 324 screwed onto the screw threads 314 of the withdrawing rod 310. That is, the head part 320 is screwed onto the withdrawing rod 310 through the through hole 324 and may previously draw the withdrawing rod 310 to the outside of the second shaft body 210 in a specific length depending on a screw coupling degree.

For example, in the mode a for a driver practice, a user's may withdraw the withdrawing rod 310 to the outside of the second shaft body 210 and also secure the initial length Lₐ of the spring member 330 for a driver practice by screwing the head part 320 onto the withdrawing rod 310 by turning the head part 320 a specific number of times. Furthermore, in the mode b for an iron practice, the user may further draw the withdrawing rod 310 to the outside of the second shaft body 210 and also adjust the initial length Lₐ of the spring member 330 to the initial length L_{b} for an iron practice by performing screw coupling with the withdrawing rod 310 by turning the head part 320 a specific number of times. Likewise, in the mode c for a wedge practice, the user may further draw the withdrawing rod 310 to the outside of the second shaft body 210 and also adjust the initial length L_{b} of the spring member 330 to the initial length L_{c} for a wedge practice by further performing screw coupling with the withdrawing rod 310 by turning the head part 320 a specific number of times.

As described above, in accordance with the present invention, a user's can have a feeling of an impact like an actual golf swing and also check whether the user takes a correct cocking and uncocking operation in person because the rod within the shaft coupled to a head is drawn out when the user takes the uncocking operation of a normal golf swing. In particular, cocking practices for each golf club are made possible and a user's convenience and portability can also be improved because the length and weight of the shaft can be adjusted in response to golf clubs having various lengths and weights from a driver to a sand wedge. Furthermore, a similarity with an actual golf swing in which an impact point of time is different for each golf club can be increased and a cocking practice effect can be improved because an impact point of time at which the rod within the shaft is drawn out as much as possible can be adjusted. Furthermore, various embodiments according to the present invention may achieve several other technical objects in addition to the contents described in this specification in related technical fields in addition to a corresponding technical field.

The detailed embodiments of the present invention have been described so far. However, those skilled in the art will evidently understand that various modification embodiments may be implemented without departing from the technical range of the present invention. Accordingly, the aforementioned disclosed embodiments should be considered from a descriptive viewpoint not a limit viewpoint. That is, the range of true technical spirit of the present invention appears in the claims and all of differences within an equivalent range thereof should be construed as being included in the present invention.

What is claimed is:

1. A portable cocking practice device, comprising:
a first shaft part which has a hollow therein and has an opening at one end thereof, which is connected to the hollow;
a second shaft part which inserted and fixed into the hollow of the first shaft part through the opening of the first shaft part over entire length or a part of the length thereof; and
a rod withdrawing part which is received inside the second shaft part so as to withdraw a given rod out of the second shaft part by an uncocking operation of a golf swing,
wherein the second shaft part comprises:
a second shaft body which has an insertion length indication part having an insertion length of each golf club that is a subject of a cocking practice indicated in an outer face and receives the rod withdrawing part therein so that a rod of the rod withdrawing part is withdrawn out through an opening part at one end; and
insertion position adjustment means for fixing the second shaft body inserted into the first shaft part to the first shaft part at a corresponding insertion position in response to an insertion length of each golf club indicated in the insertion length indication part.

2. The portable cocking practice device of claim 1, wherein the first shaft part comprises:
a first shaft body of a hollow pipe form into which the second shaft part is inserted through an opening part at one end; and
a grip part which is coupled to the other end of the first shaft body and has protrusions for a grip which guide a grip in position on an outer face.

3. The portable cocking practice device of claim 1, wherein the insertion position adjustment means comprises:
a bolt part for adjusting an insertion position which is coupled and fixed to the second shaft body; and
a nut part for adjusting an insertion position which is screwed onto the bolt part for adjusting an insertion position and fixed to an inner circumference surface of the first shaft part.

4. The portable cocking practice device of claim 3, wherein the nut part for adjusting an insertion position has guide protrusions which guide a movement in an insertion direction of the second shaft part within the first shaft part in an outer circumference surface.

5. The portable cocking practice device of claim 4, wherein the first shaft part has guide grooves corresponding to the guide protrusions in an inner circumference surface.

6. The portable cocking practice device of claim 1, wherein the rod withdrawing part comprises:
a withdrawing rod which has one end received in the second shaft body and the other end located outside the second shaft body;
a head part which has a diameter greater than an internal diameter of the second shaft body and is coupled to the other end of the withdrawing rod outside the second shaft body; and
an elastic member which is disposed within the second shaft body to restrict the one end of the withdrawing rod by an elastic force and withdraws the a given rod out of the second shaft body in a specific length by an uncocking operation of a golf swing.

7. The portable cocking practice device of claim 6, wherein the head part has a plurality of air resistance faces which increases air resistance upon playing a golf swing.

8. The portable cocking practice device of claim 6, wherein the elastic member is a coil type spring member having one end clamped to the one end of the withdrawing rod by a specific coupling member and the other end fixed within the second shaft body by a specific fixing member.

9. The portable cocking practice device of claim 6, wherein:
the withdrawing rod has screw threads in at least part of an outer circumference surface, and
the head part has a through hole screwed onto the screw threads of the withdrawing rod and is screwed onto the withdrawing rod through the through hole to withdraw a given rod out of the second shaft body in a specific length along a screw coupling degree.

10. The portable cocking practice device of claim 6, further comprising a member for adjusting an impact point of time which is disposed in the withdrawing rod portion between the head part coupled to the other end of the withdrawing rod and the second shaft body and withdraw a given rod out of the second shaft body in a specific length by separating the head part and the second shaft body.
